(19) United States
(12) Patent Application Publication
(10) Pub. No.: US 2026/0292756 A1
(43) Pub. Date: Sep. 24, 2026

(54) INFORMATION PROCESSING METHOD, SYSTEM AND APPARATUS, COMMUNICATION DEVICE, AND STORAGE MEDIUM

(71) Applicant: Beijing Xiaomi Mobile Software Co., Ltd., Beijing (CN)

(72) Inventor: Yang SHEN, Beijing (CN)

(73) Assignee: Beijing Xiaomi Mobile Software Co., Ltd., Beijing (CN)

(21) Appl. No.: 18/998,002

(22) PCT Filed: Jul. 27, 2022
(86) PCT No.: PCT/CN2022/108379

§ 371 Date: Jan. 23, 2025

(51) Int. Cl. H04W 64/00; H04W 8/22; H04W 76/14; H04W 92/18

(52) U.S. Cl. CPC H04W 64/00; H04W 8/22; H04W 76/14; H04W 92/18

(57) ABSTRACT

A method for processing information is performed by a first access and mobility management function (AMF) unit, and includes: selecting the same location management function (LMF) unit for a plurality of user equipment (UEs) involved in ranging and/or sidelink positioning.

### CROSS-REFERENCE

The present application is a U.S. National Stage of International Application No. PCT/CN 2022/108379, filed on Jul. 27, 2022, the contents of all of which are incorporated herein by reference in their entireties for all purposes.

### BACKGROUND OF THE INVENTION

In the related art, for location measurement between a plurality of user equipment (UEs), such as ranging and/or sidelink positioning and other scenarios, different location management function (LMF) units are often assigned to and access different UE for control. For example, different LMF units respectively access the plurality of UEs served by different access and mobility management function (AMF) units.

### SUMMARY OF THE INVENTION

Provided in the examples of the disclosure are a method, system and apparatus for processing information, a communication device and a storage medium.

A first aspect of an example of the disclosure provides a method for processing information, performed by a first AMF unit, including: selecting the same LMF unit for a plurality of UEs involved in at least one of ranging or sidelink positioning.

A second aspect of an example of the disclosure provides a method for processing information, performed by an LMF unit, including: performing at least one of ranging or sidelink positioning on a plurality of UEs by establishing connections with the plurality of UEs.

A third aspect of an example of the disclosure provides a method for processing information, performed by a second AMF unit, including: determining the same LMF unit selected for a plurality of UEs involved in at least one of ranging or sidelink positioning.

A fourth aspect of an example of the disclosure provides a communication device, including one or more processors, a memory, and an executable program stored on the memory and capable of being run by the one or more processors, where the one or more processors, when running the executable program, execute the method for processing information provided by the first aspect above.

A fifth aspect of an example of the disclosure provides a communication device, including one or more processors, a memory, and an executable program stored on the memory and capable of being run by the one or more processors, where the one or more processors, when running the executable program, execute the method for processing information provided by the second aspect above.

A sixth aspect of an example of the disclosure provides a communication device, including one or more processors, a memory, and an executable program stored on the memory and capable of being run by the one or more processors, where the one or more processors, when running the executable program, execute the method for processing information provided by the third aspect above.

It is to be understood that the above general descriptions and the following detailed descriptions are merely schematic and explanatory, and cannot limit the examples of the disclosure.

### BRIEF DESCRIPTION OF DRAWINGS

FIG. 1 is a schematic structural diagram of a wireless communication system shown according to an example.

FIG. 2 is a schematic flow diagram of a method for processing information shown according to an example.

FIG. 3A is a schematic diagram of UE communication shown according to an example.

FIG. 3B is a schematic diagram of UE communication shown according to an example.

FIG. 3C is a schematic diagram of UE communication shown according to an example.

FIG. 4A is a schematic diagram of a connection between UE and an LMF unit shown according to an example.

FIG. 4B is a schematic diagram of a connection between UE and an LMF unit shown according to an example.

FIG. 5 is a schematic flow diagram of a method for processing information shown according to an example.

FIG. 6 is a schematic flow diagram of a method for processing information shown according to an example.

FIG. 7 is a schematic flow diagram of a method for processing information shown according to an example.

FIG. 8 is a schematic flow diagram of a method for processing information shown according to an example.

FIG. 9 is a schematic flow diagram of a method for processing information shown according to an example.

FIG. 10 is a schematic structural diagram of an apparatus for processing information shown according to an example.

FIG. 11 is a schematic structural diagram of an apparatus for processing information shown according to an example.

FIG. 12 is a schematic structural diagram of an apparatus for processing information shown according to an example.

FIG. 13 is a schematic structural diagram of a terminal shown according to an example.

FIG. 14 is a schematic structural diagram of a communication device shown according to an example.

### DETAILED DESCRIPTION OF THE INVENTION

Examples will be illustrated in detail here, and instances of which are represented in the accompanying drawings. When the following descriptions refer to the accompanying drawings, the same number in the different accompanying drawings represents the same or similar elements unless otherwise indicated. The implementations described in the following examples do not represent all implementations consistent with examples of the disclosure. On the contrary, they are merely examples of an apparatus and a method consistent with some aspects of the examples of the disclosure.

Terms used in the examples of the disclosure are merely for the purpose of describing the particular examples, and are not intended to limit the examples of the disclosure. The singular forms “a”, “said” and “this” used in the disclosure are also intended to include the plural forms as well, unless the context clearly indicates otherwise. It is to be further understood that a term “and/or” used in this text refers to and contains any and all possible combinations of one or more associated listed items.

It is to be understood that the terms “first”, “second”, “third” and the like may be used in the examples of the disclosure to describe various information, but these pieces of information should not be limited to these terms. These terms are merely used to distinguish the same type of information from one another. For example, in a case of not departing from the scope of the examples of the disclosure, first information may also be called second information, and similarly, the second information may also be called the first information. Depending on the context, the word “if” as used here may be interpreted as “at the time of” or “when” or “in response to determining”.

The disclosure relates to the technical field of wireless communications, but is not limited to the technical field of wireless communications, in particular to a method, system and apparatus for processing information, a communication device, and a storage medium.

For location measurement between a plurality of UEs, such as ranging and/or sidelink positioning and other scenarios, different LMF units are often assigned to and access different UE for control. For example, different LMF units respectively access the plurality of UEs served by different AMF units. However, the above solution occupies a large number of LMF units, which will result in more communication interaction between the LMF units, leading to a decrease in processing efficiency.

Please refer to FIG. 1, and FIG. 1 shows a schematic structural diagram of a wireless communication system provided by an example of the disclosure. As shown in FIG. 1, the wireless communication system is a communication system based on a cellular mobile communication technology, and the wireless communication system may include: a plurality of terminals 11 and a plurality of access devices 12.

The terminal 11 may refer to a device providing voice and/or data connectivity to a user. The terminal 11 may communicate with one or more core networks via a radio access network (RAN), and the terminal 11 may be an Internet of Thing terminal, such as a sensor device, a mobile phone (or called a “cellular” phone) and a computer with the Internet of Thing terminal. For example, the terminal may be fixed, portable, pocket-sized, hand-held, computer-built or vehicle-mounted apparatuses. For example, the terminal may be a station (STA), a subscriber unit, a subscriber station, a mobile station, a mobile, a remote station, an access point, a remote terminal, an access terminal, a user apparatus (user terminal), a user agent, a user device, or a user terminal (user equipment, UE). Alternatively, the terminal 11 may also be a device of an unmanned aerial vehicle. Alternatively, the terminal 11 may also be a vehicle-mounted device, for example, a trip computer with a wireless communication function, or a wireless communication device externally connected to the trip computer. Alternatively, the terminal 11 may also be a roadside device, for example, may be a streetlight, a signal light, or other roadside devices with the wireless communication function.

The access device 12 may be a network-side device in the wireless communication system. The wireless communication system may be the 4th generation mobile communication (4G) system, also known as a long term evolution (LTE) system; alternatively, the wireless communication system may also be a 5G system, also known as a new radio (NR) system or a 5G NR system. Alternatively, the wireless communication system may also be the next-generation system of the 5G system. An access network in the 5G system may be called a new generation-radio access network (NG-RAN). Alternatively, the wireless communication system may also be a Machine-Type Communication (MTC) system.

The access device 12 may be an evolved access device (eNB) adopted in the 4G system. Alternatively, the access device 12 may also be an access device (gNB) that adopts a centralized distributed architecture in the 5G system. When the access device 12 adopts the centralized distributed architecture, the access device usually includes a central unit (CU) and at least two distributed units (DUs). The central unit is provided with protocol stacks of a packet data convergence protocol (PDCP) layer, a radio link control (RLC) protocol layer, and a media access control (MAC) layer; and the distributed unit is provided with a physical (PHY) layer protocol stack. The specific implementation of the access device 12 is not limited in the examples of the disclosure.

A wireless connection may be established between the access device 12 and the terminal 11 through a wireless air interface. In different implementations, the wireless air interface is a wireless air interface based on the 4th generation mobile communication network technology (4G) standard; alternatively, the wireless air interface is a wireless air interface based on the 5th generation mobile communication network technology (5G) standard, for example, the wireless air interface is a new radio; alternatively, the wireless air interface may also be a wireless air interface based on a next generation of 5G mobile communication network technology standard.

Alternatively, the wireless communication system as shown in FIG. 1 may further contain a network management device 13. The plurality of access devices 12 are respectively connected with the network management device 13. The network management device 13 may be a core network device in the wireless communication system. For example, the network management device 13 may be a mobility management entity (MME) in an evolved packet core (EPC) network. Alternatively, the network management device may also be other core network devices, such as a serving gateway (SGW), a public data network gateway (PGW), a policy and charging rules function (PCRF) or a home subscriber server (HSS). An implementation form of the network management device 13 is not limited in the examples of the disclosure.

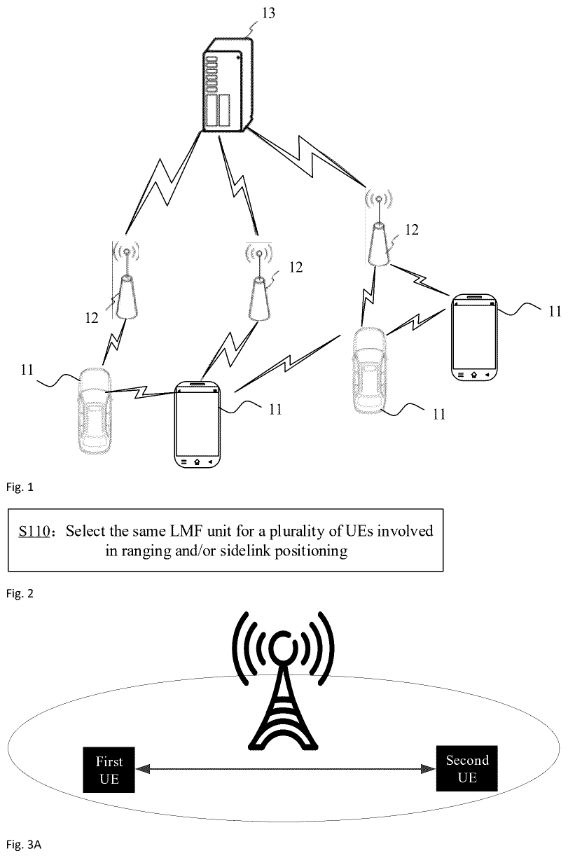

As shown in FIG. 2, an example of the disclosure provides a method for processing information, performed by a first AMF unit, including step S110.

S110: the same LMF unit is selected for a plurality of UEs involved in ranging and/or sidelink positioning.

In the example of the disclosure, the UE may be an electronic device or mobile terminal such as a mobile phone, a tablet computer, or a smartwatch. The plurality of UEs may be two or more UEs. A sidelink is a link used to directly connect the two or more UEs. The sidelink may not implement a direct connection among the UE through a base station, for example, a sidelink connection among the UEs is established through direct communication (PC5) interfaces of the plurality of UEs.

Ranging may be measuring a distance among the UEs based on the sidelink, for example, the distance between two or more UEs is determined through a PC5 interface. Sidelink positioning may be acquiring a location of the UE based on the sidelink, for example, a direction and/or a relative location of one UE with respect to another UE are/is acquired.

In one example, the UE may include: reference UE for determining a reference plane and/or reference direction in ranging and/or sidelink positioning, to-be-positioned target UE for determining at least one of a distance, a direction and a position according to the reference plane and/or the reference direction, assistant UE for providing ranging and/or sidelink positioning capability support for the reference UE and the target UE, located UE for determining its own location based on a universal user to network interface (Uu) and then for determining a location of the target UE in sidelink positioning, or location server UE for providing a location server function instead of the LMF unit, and the like.

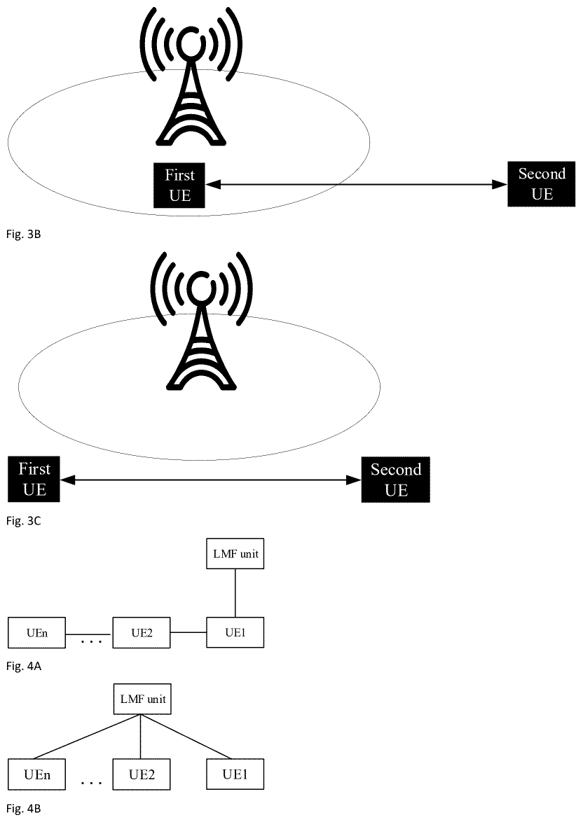

In the related art, inter-UE ranging and/or sidelink positioning may not be restricted by coverage of a base station. FIG. 3A shows ranging and/or sidelink positioning where the plurality of UEs are all located within a coverage of a base station network. FIG. 3B shows ranging and/or sidelink positioning where the plurality of UEs are partially located within the coverage of the base station network. FIG. 3C shows ranging and/or sidelink positioning where the plurality of UEs are all located outside the coverage of the base station network.

In one example, a connection manner between the plurality of UEs and the selected same LMF unit may be that one UE is connected to the LMF unit, and other UE is connected to the UE that is connected to the LMF unit, or each UE may be directly connected to the LMF unit respectively.

For example, for n UEs, namely UE1, UE2, . . . UEn, as shown in FIG. 4A, the UE1 is connected to the LMF unit, while other UEs such as the UE2, . . . the UEn are respectively connected to the UE1. As shown in FIG. 4B, the UE1, the UE2, . . . , the UEn are respectively connected to the LMF unit.

In one example, the plurality of UEs involved in ranging and/or sidelink positioning may be a plurality of UEs to be subjected to ranging, a plurality of UEs to be subjected to sidelink positioning, or a plurality of UEs to be subjected to ranging and a plurality of UEs to be subjected to sidelink positioning. For example, the first AMF unit is an AMF unit providing a service to at least one UE among the plurality of UEs, and the plurality of UEs involved in ranging and/or sidelink positioning may be a plurality of UEs indicated by a ranging and/or sidelink positioning request received by the first AMF unit.

In one example, selecting the same LMF unit for the plurality of UEs involved in ranging and/or sidelink positioning may include: selecting the same LMF unit based on capability information of the plurality of UEs involved in ranging and/or sidelink positioning. For example, the same LMF unit is selected based on ranging capability information of a plurality of UEs involved in ranging, based on sidelink positioning capability information of a plurality of UEs involved in sidelink positioning, or based on ranging capability information of a plurality of UEs involved in ranging and sidelink positioning capability information of a plurality of UEs involved in sidelink positioning.

In one example, selecting the same LMF unit for the plurality of UEs involved in ranging and/or sidelink positioning may include: selecting the same LMF unit for the plurality of UEs involved in ranging and/or sidelink positioning based on ranging and/or sidelink positioning capability information of a plurality of alternative LMF units.

For example, among the plurality of alternative LMF units, an alternative LMF unit with a best ranging capability is selected for the plurality of UEs involved in ranging, an alternative LMF unit with a best sidelink positioning capability is selected for the plurality of UEs involved in sidelink positioning, or an alternative LMF unit with a best ranging capability is selected for the plurality of UEs involved in ranging and an alternative LMF unit with a best sidelink positioning capability is selected for the plurality of UEs involved in sidelink positioning.

In one example, selecting the same LMF unit for the plurality of UEs involved in ranging and/or sidelink positioning may include: selecting the same LMF unit based on the capability information of the plurality of UEs involved in ranging and/or sidelink positioning, and ranging and/or sidelink positioning capability information of the plurality of alternative LMF units.

For example, among the plurality of alternative LMF units, an alternative LMF unit having the highest matching degree of ranging capability with the ranging capability of the plurality of UEs is selected for the plurality of UEs involved in ranging, an alternative LMF unit having the highest matching degree of sidelink positioning capability with the sidelink positioning capability of the plurality of UEs is selected for the plurality of UEs involved in sidelink positioning, or an alternative LMF unit having the highest matching degree of ranging capability with the ranging capability of the plurality of UEs is selected for the plurality of UEs involved in ranging and an alternative LMF unit having the highest matching degree of sidelink positioning capability with the sidelink positioning capability of the plurality of UEs is selected for the plurality of UEs involved in sidelink positioning.

In one example, after selecting the same LMF unit for the plurality of UEs involved in ranging and/or sidelink positioning, the method may further include: establishing connections between the plurality of UEs and the same LMF unit respectively. Establishing the connections between the plurality of UEs and the same LMF unit respectively may include establishing a connection between at least one AMF unit serving the plurality of UEs and the same LMF unit.

Here, one AMF unit may provide a service to one or more UEs, so as to control and manage the one or more UEs. The UE is directly connected to the LMF unit through the corresponding AMF unit, which achieves direct communication between the UE and LMF unit, decreases the number of communication interactions among the plurality of UEs for ranging and/or sidelink positioning through PC5 communication, and thus improve efficiency of ranging and/or sidelink positioning.

In one example, selecting the same LMF unit for the plurality of UEs involved in ranging and/or sidelink positioning may include: selecting an LMF unit for first UE served by the first AMF unit; and selecting the same LMF unit as the first UE for at least one second UE, except for the first UE, involved in ranging and/or sidelink positioning.

The first UE is one UE served by the first AMF unit, and the second UE is the other UE, except for the first UE, among the plurality of UEs involved in ranging and/or sidelink positioning. The second UE may be served by the first AMF unit, or may be served by a second AMF unit that is different from the first AMF unit.

In one example, selecting the same LMF unit as the first UE for the at least one second UE may include: indicating, in a case where the second UE is not served by the first AMF unit, the LMF unit selected for the first UE to the second AMF unit providing a service to the second UE, or indicating the second AMF unit providing the service to the second UE to the LMF unit selected for the first UE.

In one example, selecting the same LMF unit as the first UE for the at least one second UE may include: indicating, in a case where the second UE is served by the first AMF unit, a UE identifier of the second UE to the LMF unit selected for the first UE. For example, the UE identifier may include the UE identity information (ID) or a UE serial number of the second UE.

In this way, by controlling the plurality of UEs that require ranging and/or sidelink positioning through the same LMF unit, the number of occupied LMF units is reduced in a process of performing ranging and/or sidelink positioning, and communication interaction among the plurality of LMF units can be reduced, thus complexity of collaborative work among the plurality of LMF units is reduced, and efficiency for performing the ranging and/or sidelink positioning is improved.

As shown in FIG. 5, an example of the disclosure provides a method for processing information, performed by a first AMF unit, including step S111.

S111: in a case where a ranging and/or sidelink positioning request is received, the same LMF unit is selected for the plurality of UEs based on an AMF unit providing a service to the plurality of UEs; where the plurality of UEs are indicated by the ranging and/or sidelink positioning request.

In the example of the disclosure, the ranging and/or sidelink positioning request may be a ranging request indicating the execution of ranging, a positioning request indicating the execution of sidelink positioning, or a request indicating the execution of ranging and sidelink positioning. The ranging and/or sidelink positioning request may indicate the plurality of UEs that perform ranging and/or sidelink positioning, for example, the ranging and/or sidelink positioning request may indicate at least one of target UE, reference UE, assistant UE, located UE, and location server UE.

In one example, the ranging and/or sidelink positioning request may be sent by the UE or a gateway mobile location center (GMLC) or a network function (NF) unit, for example, the NF unit may be a 5G core network (5GC) NF unit, etc.

For example, receiving the ranging and/or sidelink positioning request may refer to receiving the ranging and/or sidelink positioning request sent by at least one of the target UE, the reference UE, the assistant UE, the located UE, and the location server UE.

In one example, the AMF unit providing the service to the plurality of UEs may be the same AMF unit, such as the first AMF unit, or a plurality of different AMF units, such as a first AMF unit serving first UE and a second AMF unit serving second UE.

In one example, selecting the same LMF unit for the plurality of UEs based on the AMF unit providing the service to the plurality of UEs may include selecting the same LMF unit by the AMF unit providing the service to the plurality of UEs. In a case where the plurality of AMF units provide the services to the plurality of UEs, the same LMF unit may be determined through negotiation among the plurality of AMF units.

For example, in a case where the AMF unit providing the service to the plurality of UEs includes the first AMF unit and the second AMF unit, the first AMF unit and the second AMF unit may respectively select one LMF unit, and negotiate based on the selected LMF unit. If consistent, it is determined that the selected LMF units are the same LMF unit.

In one example, selecting the same LMF unit for the plurality of UEs based on the AMF unit providing the service to the plurality of UEs may include: selecting, in a case where the AMF unit providing the service to the plurality of UEs includes the first AMF unit and at least one second AMF unit, one LMF unit by the first AMF unit and indicating the LMF unit to the at least one second AMF unit.

In one example, selecting the same LMF unit for the plurality of UEs based on the AMF unit providing the service to the plurality of UEs may include: selecting, in a case where the AMF unit providing the service to the plurality of UEs includes the first AMF unit and at least one second AMF unit, one LMF unit by the first AMF unit and indicating the at least one second AMF unit to the LMF unit.

In some examples, selecting the same LMF unit for the plurality of UEs based on the AMF unit providing the service to the plurality of UEs may include: selecting an LMF unit for first UE served by a first AMF unit among the plurality of UEs; determining whether at least one second UE indicated by the ranging and/or sidelink positioning request is served by the first AMF unit; determining a second AMF unit providing a service to the second UE in a case where the second UE is not served by the first AMF unit; and selecting the same LMF unit for the second UE based on the LMF unit and the second AMF unit.

In the example of the disclosure, the first UE may be the target UE or reference UE indicated by the ranging and/or sidelink positioning request, and the first UE may be at least one UE served by the first AMF unit that receives the ranging and/or sidelink positioning request.

In one example, in a case where there are the plurality of UEs served by the first AMF unit, the first UE may be UE with the highest priority among the plurality of UEs served by the first AMF unit. The priority may be pre-set and may be determined according to an identity of the UE in ranging and/or sidelink positioning. For example, the order of the priority from high to low may be sequentially: the target UE, the reference UE, the assistant UE, the location server UE, and the located UE, etc.

In one example, selecting the LMF unit for the first UE may refer to sending a UE identifier of the first UE to the LMF unit.

In one example, selecting the LMF unit for the first UE served by the first AMF unit among the plurality of UEs may include: selecting the LMF unit for the first UE among alternative LMF units based on capability information of the first UE served by the first AMF unit among the plurality of UEs and/or capability information of the plurality of alternative LMF units.

For example, an LMF unit having the highest matching degree of capability information with the capability information of the first UE is selected among the plurality of alternative LMF units.

The capability information may include a ranging and/or sidelink positioning capability of the UE or the LMF unit, such as accuracy of performing ranging and/or sidelink positioning or a supported ranging and/or sidelink positioning type. The ranging and/or sidelink positioning type here may include ordinary positioning and inter-UE PC5-based sidelink positioning.

In one example, selecting the LMF unit for the first UE served by the first AMF unit among the plurality of UEs may include: selecting the LMF unit for the first UE served by the first AMF unit among the plurality of UEs based on ranging and/or sidelink positioning demand information indicated by the ranging and/or sidelink positioning request.

For example, the LMF unit is selected for the first UE among the alternative LMF units based on the ranging and/or sidelink positioning demand information, and the capability information of the plurality of alternative LMF units.

For example, it may include: an LMF unit having the highest matching degree of capability information with the ranging and/or sidelink positioning demand information is selected among the plurality of alternative LMF units.

In one example, the second UE is other UE, except for the first UE, among the plurality of UEs. In a case where the second UE is not served by the first AMF unit, the same LMF unit as the one selected for the first UE is selected for the second UE based on the LMF unit and the second AMF unit serving the second UE. For example, the first AMF unit may indicating the LMF unit selected for the first UE to the second AMF unit providing the service to the second UE, or indicate the second AMF unit to the LMF unit selected for the first UE.

In this way, by specifying the same LMF unit to the second AMF unit providing the service to other UE through the first AMF unit, resource waste caused by selecting the LMF unit by the plurality of AMF units respectively may be reduced, communication interactions caused by negotiating to determine the same LMF unit by the plurality of AMF units may also be reduced, and thus information processing efficiency is improved.

In some examples, selecting the same LMF unit for the second UE based on the LMF unit and the second AMF unit may include: selecting the same LMF unit for the second UE by indicating the LMF unit to the second AMF unit.

In the example of the disclosure, indicating the LMF unit to the second AMF unit may refer to indicating the LMF unit selected for the first UE to the second AMF unit, so as to specifying that the LMF unit serving the second UE is consistent with the LMF unit serving the first UE.

In one example, indicating the LMF unit selected for the first UE to the second AMF unit may include: sending a unit identifier of the LMF unit selected for the first UE to the second AMF unit. For example, the unit identifier of LMF unit may be an LMF unit ID, etc.

In some examples, selecting the same LMF unit for the second UE based on the LMF unit and the second AMF unit may include: selecting the same LMF unit for the second UE by indicating the second AMF unit to the LMF unit.

In some examples, indicating the second AMF unit to the LMF unit may include: sending a unit identifier of the second AMF unit to the LMF unit.

Here, the unit identifier of the second AMF unit may include a unit ID of the second AMF unit, etc. The unit identifier may be acquired by the first AMF unit from the second AMF unit, for example, the unit identifier is sent by the second AMF unit to the first AMF unit, or queried by the first AMF unit from a unified data management (UDM) unit.

In one example, the unit identifier of the second AMF unit may be carried in the connection request and sent to the LMF unit, for example, the connection request is used to indicate that the LMF unit establishes a connection with the corresponding second UE through the second AMF unit.

In some examples, the method may further include: selecting, in a case where the second UE is served by the first AMF unit, the same LMF unit for the second UE by indicating a UE identifier of the second UE to the LMF unit.

In the example of the disclosure, the UE identifier may be a UE ID or a UE serial number, etc. In a case where both the first UE and the second UE are served by the first AMF unit, the first AMF unit may designate an LMF unit to serve the first UE and the second UE. For example, the UE identifier of the second UE may be sent to the LMF unit to establish a connection between the second UE and the LMF unit through the first AMF unit.

In one example, indicating the UE identifier of the second UE to the LMF unit may include: sending UE identifiers of the first UE and the second UE to the LMF unit, so as to enable the LMF unit to establish connections with the first UE and the second UE through the first AMF unit.

In one example, sending the UE identifiers of the first UE and the second UE to the LMF unit may include: sending a connection request carrying the UE identifiers of the first UE and the second UE to the LMF unit, where the connection request indicates that the LMF unit establishes the connections with the first UE and the second UE through the first AMF unit.

In some examples, indicating the UE identifier of the second AMF unit to the LMF unit may include: sending a connection request carrying the UE identifier of the second UE to the LMF unit.

In this way, the connection between the UE and the LMF unit is established through interaction of the UE identifier, the data amount of communication interaction can be reduced, and processing efficiency is further improved.

In some examples, determining the second AMF unit providing the service to the second UE may include: querying, based on the UE identifier of the second UE, the unified data management (UDM) unit for the second AMF unit providing the service to the second UE.

In the example of the disclosure, the UDM unit may record an association relationship between the UE and the AMF unit providing the service to the UE, for example, the UDM unit records an association relationship between the UE identifier of the UE and the unit identifier of the AMF unit providing the service to the UE.

Here, the unit identifier may be a unit ID or a unit serial number of the AMF unit.

In one example, querying, based on the UE identifier of the second UE, the unified data management (UDM) unit for the second AMF unit providing the service to the second UE may include: querying, based on the UE identifier of the second UE, the unified data management UDM unit for an association relationship corresponding to the UE identifier; and determining the second AMF unit providing the service to the second UE based on the association relationship.

In one example, determining the second AMF unit providing the service to the second UE based on the association relationship may include: determining the unit identifier of the second AMF unit providing the service to the second UE based on the association relationship; and querying the corresponding second AMF unit based on the unit identifier.

In some examples, the method may further include: establishing connections between the plurality of UEs and the LMF unit through the first AMF unit and the second AMF unit.

In the example of the disclosure, establishing the connections between the plurality of UEs and the LMF unit through the first AMF unit and the second AMF unit may refer to establishing the connections between the plurality of UEs and the LMF unit by establishing the connection between the LMF unit and the first AMF unit and establishing the connection through the second AMF unit.

In one example, establishing the connections between the plurality of UEs and the LMF unit through the first AMF unit and the second AMF unit may include: establishing the connection between the first UE and the LMF unit by establishing the connection between the LMF unit and the first AMF unit, and establishing the connection between the second UE and the LMF unit by establishing the connection between the LMF unit and the second AMF unit.

In some examples, as shown in FIG. 6, the method may further include steps S120 and S130, in addition to previously described step S110.

S120: a ranging and/or sidelink positioning result sent by the LMF unit is received.

S130: the ranging and/or sidelink positioning result is reported.

In the example of the disclosure, the ranging and/or sidelink positioning result may be a result determined by the LMF unit based on the ranging and/or sidelink positioning performed by the connected first UE and second UE after establishing the connection between the first UE as well as the second UE and the LMF unit. After determining the ranging and/or sidelink positioning result, the LMF unit may send the ranging and/or sidelink positioning result to the first AMF unit.

In one example, the first AMF unit is used to perform selection of the LMF unit and interaction with the LMF unit, so that the LMF unit sends the ranging and/or sidelink positioning result between the first UE and the second UE to the first AMF unit for management. The first AMF unit may report the ranging and/or sidelink positioning result received from the LMF unit to the server or the UDM unit.

In this way, by receiving and reporting the ranging and/or sidelink positioning result through the first AMF unit that receives the ranging and/or sidelink positioning request, a communication interaction process between other AMF units and the LMF unit can be reduced, the processing efficiency is further improved, and the complexity of the ranging and/or sidelink positioning process is reduced.

As shown in FIG. 7, an example of the disclosure provides a method for processing information, performed by an LMF unit. The method may include step S210.

S210: ranging and/or sidelink positioning is performed on a plurality of UEs by establishing connections with the plurality of UEs.

In the example of the disclosure, establishing the connections with the plurality of UEs may refer to establishing the connections with the plurality of UEs through at least one AMF unit serving the plurality of UEs. For example, the connections with the plurality of UEs are established through at least one AMF unit serving the plurality of UEs.

In some examples, establishing the connections with the plurality of UEs may include: establishing a connection with first UE served by a first AMF unit through the first AMF unit; receiving a unit identifier, sent by the first AMF unit, of a second AMF unit providing a service to second UE; and establishing a connection with the second UE by sending a connection request to the second AMF unit based on the unit identifier.

In one example, the first AMF unit is an AMF unit that receives a ranging and/or sidelink positioning request, and the first UE may be target UE or reference UE indicated in the ranging and/or sidelink positioning request.

In a case where there are the plurality of UEs served by the first AMF unit, the first UE may be UE with the highest priority among the plurality of UEs served by the first AMF unit. The priority may be pre-set and may be determined according to an identity of the UE in ranging and/or sidelink positioning. For example, the order of the priority from high to low may be sequentially: the target UE, the reference UE, the assistant UE, the location server UE, and the located UE, etc.

In one example, establishing the connection with the first UE served by the first AMF unit through the first AMF unit may include: establishing the connection with the first UE served by the first AMF unit by receiving a UE identifier of the first UE sent by the first AMF unit.

In one example, receiving the unit identifier, sent by the first AMF unit, of the second AMF unit providing the service to second UE may include: receiving a connection request, sent by the first AMF unit, carrying the unit identifier of the second AMF unit providing the service to the second UE.

In one example, sending the connection request to the second AMF unit based on the unit identifier may refer to sending the connection request received from the first AMF unit to the second AMF unit. The connection request may carry the unit identifier of the second AMF unit, and may further carry the unit identifier of the LMF unit.

In one example, establishing the connection with the second UE may refer to establishing the connection with the second UE by establishing the connection with the second AMF unit based on the connection request.

In some examples, establishing the connections with the plurality of UEs may include:

establishing the connection with first UE served by the first AMF unit through the first AMF unit; receiving the connection request sent by the second AMF unit providing the service to second UE; and establishing the connection with the second UE based on the connection request.

In the example of the disclosure, the connection request sent by the second AMF unit may be a connection request sent by the second AMF unit based on the AMF unit indicated by the first AMF unit, such as a connection request sent based on the unit identifier of the LMF unit indicated by the first AMF unit.

In one example, establishing the connection with the second UE based on the connection request may refer to establishing the connection with the second UE based on the connection with the second AMF unit indicated by the connection request. For example, the connection with the second UE is established based on a connection with the second AMF unit corresponding to the unit identifier carried by the connection request.

In some examples, establishing the connections with the plurality of UEs may include:

establishing the connection with first UE served by the first AMF unit through the first AMF unit; receiving the connection request sent by the first AMF unit; and establishing the connection with the second UE based on a UE identifier, carried by the connection request, of the second UE served by the first AMF unit.

In the example of the disclosure, the UE identifier may be a UE ID or a UE serial number, etc. In a case where both the first UE and the second UE are served by the first AMF unit, the first AMF unit may directly designate an LMF unit to serve the first UE and the second UE. For example, the LMF unit may receive the UE identifier of the second UE sent by the first AMF unit, so as to establish the connection between the second UE and the LMF unit through the first AMF unit.

In one example, the connection request sent by the first AMF unit may carry UE identifiers of the first UE and the second UE.

In one example, establishing the connection with the second UE may refer to establishing the connection with the second UE by connecting with the first AMF unit.

In some examples, the method may further include: determining a indication information and a calculation mode for ranging and/or sidelink positioning information based on capability negotiation results with the plurality of UEs; sending the indication information to the plurality of UEs; obtaining a ranging and/or sidelink positioning result by calculating, based on the calculation mode, the ranging and/or sidelink positioning information sent by the plurality of UEs based on the indication information; and sending the ranging and/or sidelink positioning result to a first AMF unit.

In the example of the disclosure, the capability negotiation results with the plurality of UEs may be results such as capability information acquired by the LMF unit through capability negotiation with the plurality of UEs. The capability negotiation may include interaction acquisition of the capability information between the LMF unit and the plurality of UEs.

The capability negotiation results may include at least one of the following: ranging and/or sidelink positioning capabilities of the plurality of UEs; a ranging and/or sidelink positioning capability of the LMF unit; or a calculation node indicated by the UE for calculating the ranging and/or sidelink positioning information.

In one example, the ranging and/or sidelink positioning capability may be the ranging and/or sidelink positioning capability information. The capability information may indicate a ranging and/or sidelink positioning capability of the UE or the LMF unit, such as accuracy of performing ranging and/or sidelink positioning or a supported ranging and/or sidelink positioning type.

The ranging and/or sidelink positioning type here may include ordinary positioning and inter-UE PC5-based sidelink positioning.

In one example, the calculation node indicated by the UE for calculating ranging and/or sidelink positioning information may be a calculation node expected by the UE for calculating the ranging and/or sidelink positioning information. The calculation node may include one or more of the plurality of UEs, or the LMF unit.

In one example, determining the indication information and the calculation mode for the ranging and/or sidelink positioning information based on the capability negotiation results with the plurality of UEs may include: determining operator preference information for the plurality of UEs and/or the LMF unit based on the capability negotiation results with the plurality of UEs; and determining the indication information and the calculation mode for the ranging and/or sidelink positioning information based on the operator preference information for the plurality of UEs and/or the LMF unit.

Here, the operator preference information may indicate the calculation mode expected by the operator based on an operator policy and the capability negotiation results of the LMF unit and the plurality of UEs. For example, the calculation mode may include calculation nodes and/or calculation manners for the ranging and/or sidelink positioning information. For example, the calculation mode indicates that the calculation of the ranging and/or sidelink positioning information is performed at the first UE, the second UE, or the LMF unit.

In one example, the ranging and/or sidelink positioning information may be ranging data and/or positioning data obtained by performing ranging and/or sidelink positioning by the UE. The ranging and/or sidelink positioning result may be obtained by calculating the ranging and/or sidelink positioning information.

In one example, the indication information indicates at least one of the following: performing ranging and/or sidelink positioning among the plurality of UEs; sending the ranging and/or sidelink positioning information to the LMF unit by the plurality of UEs; or sending the ranging and/or sidelink positioning result to the LMF unit by the plurality of UEs.

Here, the indication information may be used to instruct the plurality of UEs to perform ranging, or to instruct the plurality of UEs to perform sidelink positioning, etc. The indication information may further indicate a content reported by the plurality of UEs to the LMF unit.

For example, when the calculation mode indicates that the first UE is the calculation node for calculating the ranging and/or sidelink positioning information, the indication information may indicate that the first UE reports the ranging and/or sidelink positioning result obtained after calculating the ranging and/or sidelink positioning information.

For example, when the calculation mode indicates that the LMF unit is the calculation node for calculating the ranging and/or sidelink positioning information, the indication information may instruct the UE to report the ranging and/or sidelink positioning information for calculation in the LMF unit.

In some examples, the method may further include: acquiring, based on the calculation mode, the ranging and/or sidelink positioning result calculated and sent by at least one of the plurality of UEs based on the indication information.

In some examples, the capability negotiation results include at least one of the following: ranging and/or sidelink positioning capabilities of the plurality of UEs; a ranging and/or sidelink positioning capability of the LMF unit; or a calculation node indicated by the UE for calculating the ranging and/or sidelink positioning information.

In some examples, the indication information indicates at least one of the following: performing ranging and/or sidelink positioning among the plurality of UEs; sending the ranging and/or sidelink positioning information to the LMF unit by the plurality of UEs; or sending the ranging and/or sidelink positioning result to the LMF unit by the plurality of UEs.

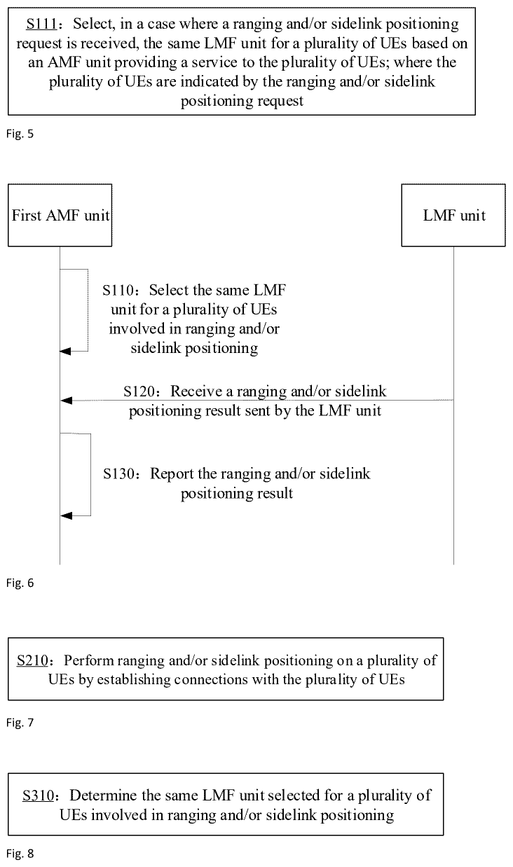

As shown in FIG. 8, an example of the disclosure provides a method for processing information, performed by a second AMF unit. The method may include step S310.

S310: the same LMF unit selected for a plurality of UEs involved in ranging and/or sidelink positioning is determined.

In the example of the disclosure, determining the same LMF unit selected for the plurality of UEs involved in ranging and/or sidelink positioning may refer to determining the LMF unit indicated by a first AMF unit and selected for the plurality of UEs involved in ranging and/or sidelink positioning. For example, it may include: receiving a unit identifier of the LMF unit sent by the first AMF unit and selected by the plurality of UEs involved in ranging and/or sidelink positioning.

Here, the second AMF unit may provide a service to second UE among the plurality of UEs, while the first AMF unit may provide a service to first UE among the plurality of UEs.

In some examples, determining the same LMF unit selected for a plurality of UEs involved in ranging and/or sidelink positioning may include: determining the LMF unit indicated by the first AMF unit and selected for the plurality of UEs involved in ranging and/or sidelink positioning.

In some examples, the method may further include: establishing a connection between at least one second UE served by the second AMF unit and the LMF unit by sending a connection request to the LMF unit.

In the example of the disclosure, sending the connection request to the LMF unit may include: sending the connection request to the LMF unit indicated by the unit identifier sent by the first AMF unit.

Here, the connection request sent to the LMF unit may carry a unit identifier of the second UE, and may further carry the unit identifier of the LMF unit.

In some examples, the method may further include: receiving the connection request sent by the LMF unit; and establishing the connection between the at least one second UE served by the second AMF unit and the LMF unit.

In the example of the disclosure, receiving the connection request sent by the LMF unit may refer to receiving the connection request sent by the LMF unit based on the unit identifier of the second AMF unit indicated by the first AMF unit. The connection request may carry the unit identifier of the LMF unit.

In one example, establishing the connection between the at least one second UE served by the second AMF unit and the LMF unit may include: establishing the connection between the at least one second UE served by the second AMF unit and the LMF unit by connecting the second AMF unit with the LMF unit.

In one example, connecting the second AMF unit with the LMF unit may include: connecting the second AMF unit with the LMF unit corresponding to the unit identifier carried in the received connection request.

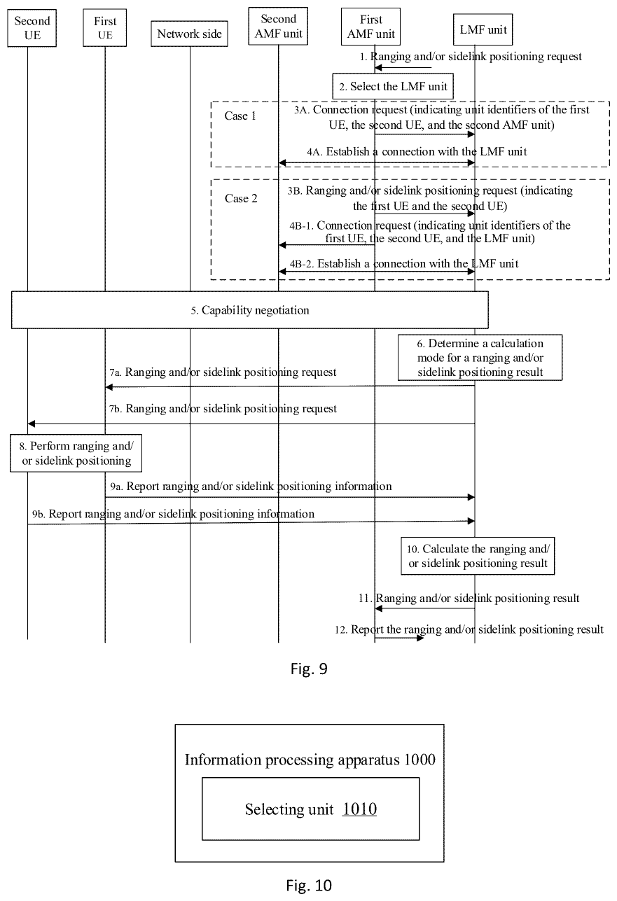

An example of the disclosure provides a method for processing information for ranging and/or sidelink positioning. Specifically, as shown in FIG. 9, the method may include the following steps 1-12.

1. a ranging and/or sidelink positioning request from UE, or GMLC, or any 5GC NF is received by a first AMF unit (an AMF unit providing a service to first UE).

2. An LMF unit is selected by the first AMF unit for the first UE.

### Case 1

3A. In a case where all the UEs involved in the ranging and/or sidelink positioning process (taking merely second UE as an example) are served by the first AMF unit, the first AMF unit also selects the same LMF unit for them and sends a connection request to the selected LMF unit, and the request includes UE identifiers of the first UE and the second UE. Otherwise, the first AMF unit queries a UDM for a serving AMF unit (being a second AMF unit in this process) of the UE that is not served by the first AMF unit, and provides a unit ID of the second AMF unit to the selected LMF unit, indicating that it is the serving AMF unit of the second UE.

4A. The LMF unit requests to establish a ranging and/or sidelink positioning connection with the second AMF unit. The ranging and/or sidelink positioning connection is successfully established between the LMF unit and the second AMF unit.

### Case 2

3B. The first AMF unit also selects the same LMF for all the UEs involved in the ranging and/or sidelink positioning process, and sends the ranging and/or sidelink positioning request to the selected LMF, which includes all UE IDs (being a first UE ID and a second UE ID in this process).

4B-1. In a case where all the UEs involved in the ranging and/or sidelink positioning process are served by the first AMF unit, steps 4B-1 and 4B-2 are skipped. Otherwise, the first AMF unit queries the UDM for the serving AMF unit (being the second AMF unit in this process) of the UE that is not served by the first AMF unit, and sends the connection request to the second AMF unit to indicate the selected LMF unit.

4B-2. The second AMF unit requests to establish a ranging and/or sidelink positioning connection with the LMF unit, and the LMF unit establishes the ranging and/or sidelink positioning connection with the second AMF unit.

5. The LMF unit negotiates a ranging and/or sidelink positioning capability with the first UE and the second UE to acquire capabilities of the first UE and the second UE, and preferences of the first UE and the second UE for a ranging and/or sidelink positioning calculation node.

6. The LMF unit determines, according to the ranging and/or sidelink positioning capability of the LMF unit, the ranging and/or sidelink positioning capability of the UE, and the UE preference of the ranging and/or sidelink positioning calculation node, a new calculation manner and indication information for ranging and/or sidelink positioning, that is, an operator policy of the UE and/or the LMF unit, that is, an operator preference of the UE and/or the LMF unit.

7. The LMF unit sends indication information of a ranging and/or sidelink to the first UE and the second UE respectively, and the indication information carries the requested information (i.e. at least one of ranging and/or sidelink positioning information and a ranging and/or sidelink positioning result).

8. The ranging and/or sidelink positioning is performed by the first UE and the second UE. In a case where the indication information merely requests the ranging and/or sidelink positioning information or selects a calculation mode based on the LMF unit, the UE does not need to perform result calculation.

9. The first UE and the second UE respectively report ranging and/or sidelink positioning measurement data to the LMF unit according to demands.

10. The ranging and/or sidelink positioning result is calculated by the LMF unit according to the ranging and/or sidelink positioning information received from the first UE and the second UE.

11. The ranging and/or sidelink positioning result is reported by the LMF unit to the first AMF unit.

12. The ranging and/or sidelink positioning result is reported by the first AMF unit.

The same LMF unit is selected for all the UEs involved in the ranging and/or sidelink positioning process to avoid complexity caused by coordination among the plurality of LMF units.

The UE directly communicates with the LMF unit, avoiding capability negotiation and sharing among the UE through PC5 communication.

All the UEs involved in the example of the disclosure need to establish communication with the LMF unit, at least for: determining the calculation mode based on the capability negotiation result; triggering energy-saving UE to enable a ranging and/or sidelink positioning function; and guiding and reporting to obtain the ranging and/or sidelink positioning result.

An example of the disclosure provides an information processing system, including: a first AMF unit, a second AMF unit, and an LMF unit, where the first AMF unit is configured to select the same LMF unit for a plurality of UEs involved in ranging and/or sidelink positioning and served by the first AMF unit and the second AMF unit by indicating to establish a connection between the second AMF unit and the LMF unit; the second AMF unit is communicatively connected with the first AMF unit, and is configured to establish a connection with the LMF unit based on indication of the first AMF unit; and the LMF unit is configured to establish a connection with the second AMF unit based on indication of the first AMF unit.

In the example of the disclosure, the first AMF unit and the second AMF unit are configured to provide services to a plurality of UEs involved in ranging and/or sidelink positioning. For example, the first AMF unit may provide the service to at least one first UE, and the second AMF unit may provide the service to at least one second UE.

In one example, the first AMF unit is configured to select, after determining the corresponding LMF unit for the first UE, the same LMF unit for the plurality of UEs involved in ranging and/or sidelink positioning and served by the first AMF unit and the second AMF unit by indicating to establish a connection between the second AMF unit and the LMF unit.

In one example, determining the corresponding LMF unit for the first UE may include: determining the corresponding LMF unit for the first UE based on capability information of the first UE and ranging and/or sidelink positioning capability information of a plurality of alternative LMF units.

For example, among the plurality of alternative LMF units, an LMF unit having the highest matching degree of ranging capability with the ranging capability of the first UE is selected for the first UE, and/or an LMF unit having the highest matching degree of sidelink positioning capability with the sidelink positioning capability of the first UE is selected for the first UE.

The capability information may include a ranging and/or sidelink positioning capability of the UE or the LMF unit, such as accuracy of performing ranging and/or sidelink positioning or a supported ranging and/or sidelink positioning type. The ranging and/or sidelink positioning type here may include ordinary positioning and inter-UE PC5-based sidelink positioning.

In one example, the first AMF unit is further configured to establish a connection between the first UE served by the first AMF unit and the LMF unit by connecting with the LMF unit.

In one example, the first UE is connected with the LMF unit by establishing the connection between the first AMF unit and the LMF unit.

In one example, the second UE is connected with the LMF unit by establishing a connection between the second AMF unit and the LMF unit.

In one example, the first AMF unit may further be configured to: query, based on a UE identifier of the second UE, a UDM unit for the second AMF unit providing a service to the second UE. For example, the first AMF unit may be configured to query the UDM unit for a unit identifier of the second AMF unit.

In one example, the LMF unit may further be configured to determine a ranging and/or sidelink positioning result, for example, the LMF unit may be configured to acquire a ranging result and/or a sidelink positioning result among the plurality of UEs, or the LMF unit may be configured to receive ranging and/or sidelink positioning information sent by at least one UE among the plurality of UEs, and calculate the ranging and/or sidelink positioning result based on the ranging and/or sidelink positioning information.

In one example, the LMF unit may further be configured to send the ranging and/or sidelink positioning result to the first AMF unit, and the first AMF unit may further be configured to receive and report the ranging and/or sidelink positioning result.

In this way, by controlling the plurality of UEs that require ranging and/or sidelink positioning through the same LMF unit, the number of occupied LMF units is reduced in a process of performing ranging and/or sidelink positioning, and communication interaction among the plurality of LMF units can be reduced, thus complexity of collaborative work among the plurality of LMF units is reduced, and efficiency for performing the ranging and/or sidelink positioning is improved.

In some examples, the first AMF unit is configured to send a unit identifier of the second AMF unit to the LMF unit.

The LMF unit is configured to establish a connection with the second AMF unit based on the unit identifier of the second AMF unit.

Here, the unit identifier of LMF unit may be an LMF unit ID, etc.

In some examples, the first AMF unit is configured to send a unit identifier of the LMF unit to the second AMF unit; and
the second AMF unit is configured to establish a connection with the LMF unit based on the unit identifier of the LMF unit.

In one example, the unit identifier of the second AMF unit may include a unit ID of the second AMF unit, etc. The unit identifier of the second AMF unit may be acquired by the first AMF unit from the second AMF unit, for example, the unit identifier is sent by the second AMF unit to the first AMF unit, or queried by the first AMF unit from the UDM unit.

In one example, the unit identifier of the second AMF unit may be carried in the connection request and sent to the LMF unit, for example, the connection request is used to indicate that the LMF unit establishes a connection with the corresponding second UE through the second AMF unit.

As shown in FIG. 10, an example of the disclosure provides an information processing apparatus 1000, applied to a first AMF unit, including a selecting unit 1010.

The selecting unit 1010, configured to select the same LMF unit for a plurality of UEs involved in ranging and/or sidelink positioning.

In some examples, the selecting unit 1010 is configured to: select, in a case where a ranging and/or sidelink positioning request is received, the same LMF unit for the plurality of UEs based on an AMF unit providing a service to the plurality of UEs; where the plurality of UEs are indicated by the ranging and/or sidelink positioning request.

In some examples, the selecting unit 1010 is configured to: select an LMF unit for first UE served by a first AMF unit among the plurality of UEs; determine whether at least one second UE indicated by the ranging and/or sidelink positioning request is served by the first AMF unit; determine a second AMF unit providing a service to the second UE in a case where the second UE is not served by the first AMF unit; and select the same LMF unit for the second UE by indicating the second AMF unit to the LMF unit, or indicating the LMF unit to the second AMF unit.

In some examples, the selecting unit 1010 is configured to: send a unit identifier of the second AMF unit to the LMF unit.

In some examples, the selecting unit 1010 is further configured to: select, in a case where the second UE is served by the first AMF unit, the same LMF unit for the second UE by indicating a UE identifier of the second UE to the LMF unit.

In some examples, the selecting unit 1010 is configured to: send a connection request carrying the UE identifier of the second UE to the LMF unit.

In some examples, the selecting unit 1010 is configured to: query, based on a UE identifier of the second UE, a unified data management (UDM) unit for the second AMF unit providing the service to the second UE.

In some examples, the apparatus 1000 further includes: a first connection unit (not shown), configured to establish connections between the plurality of UEs and the LMF unit through the first AMF unit and the second AMF unit.

In some examples, the apparatus 1000 further includes: an interaction unit (not shown), configured to receive a ranging and/or sidelink positioning result sent by the LMF unit; and report the ranging and/or sidelink positioning result.

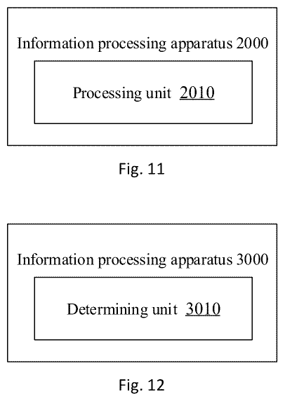

As shown in FIG. 11, an example of the disclosure provides an information processing apparatus 2000, applied to an LMF unit, including a processing unit 2010.

The processing unit 2010, configured to perform ranging and/or sidelink positioning on a plurality of UEs by establishing connections with the plurality of UEs.

In some examples, the processing unit 2010 is configured to: establish a connection with first UE served by a first AMF unit through the first AMF unit; receive a unit identifier, sent by the first AMF unit, of a second AMF unit providing a service to second UE; and establish a connection with the second UE by sending a connection request to the second AMF unit based on the unit identifier.

In some examples, the processing unit 2010 is configured to: establish a connection with first UE served by a first AMF unit through the first AMF unit; receive a connection request sent by a second AMF unit providing a service to second UE; and establish a connection with the second UE based on the connection request.

In some examples, the processing unit 2010 is configured to: establish a connection with first UE served by a first AMF unit through the first AMF unit; receive a connection request sent by the first AMF unit; and establish a connection with second UE based on a UE identifier, carried by the connection request, of the second UE served by the first AMF unit.

In some examples, the apparatus 2000 further includes: a negotiation unit (not shown), configured to determine indication information and a calculation mode for ranging and/or sidelink positioning information based on capability negotiation results with the plurality of UEs; send the indication information to the plurality of UEs; obtain a ranging and/or sidelink positioning result by calculating, based on the calculation mode, the ranging and/or sidelink positioning information sent by the plurality of UEs based on the indication information; and send the ranging and/or sidelink positioning result to a first AMF unit.

In some examples, the apparatus 2000 further includes: an acquiring unit (not shown), configured to acquire, based on the calculation mode, the ranging and/or sidelink positioning result calculated and sent by at least one of the plurality of UEs based on the indication information.

In some examples, the capability negotiation results include at least one of the following: ranging and/or sidelink positioning capabilities of the plurality of UEs; a ranging and/or sidelink positioning capability of the LMF unit; or a calculation node indicated by the UE for calculating the ranging and/or sidelink positioning information.

In some examples, the indication information indicates at least one of the following: performing ranging and/or sidelink positioning among the plurality of UEs; sending the ranging and/or sidelink positioning information to the LMF unit by the plurality of UEs; or sending the ranging and/or sidelink positioning result to the LMF unit by the plurality of UEs.

As shown in FIG. 12, an example of the disclosure provides an information processing apparatus 3000, applied to a second AMF unit, including a determining unit 3010.

The determining unit 3010, configured to determine the same LMF unit selected for a plurality of UEs involved in ranging and/or sidelink positioning.

In some examples, the determining unit 3010 is configured to: determine the LMF unit indicated by a first AMF unit and selected for the plurality of UEs involved in ranging and/or sidelink positioning.

In some examples, the apparatus 3000 further includes: a second connection unit (now shown), configured to establish a connection between at least one second UE served by the second AMF unit and the LMF unit by sending a connection request to the LMF unit.

In some examples, the apparatus 3000 further includes: a third connection unit(now shown), configured to receive the connection request sent by the LMF unit; and establish the connection between the at least one second UE served by the second AMF unit and the LMF unit.

An example of the disclosure provides a communication device, including: a memory, configured to store executable instructions of the processor, where the processor, respectively connected with the memory; where the processor is configured to execute a method for processing information provided by any of the above technical solutions.

The processor may include various types of storage media, which are non-transitory computer storage media that can continue to memorize information stored on it after the communication device is powered down.

Here, the communication device includes: a terminal or a network element, and the network element may be any one of a first network element to a fourth network element mentioned above.

The processor may be connected with the memory through a bus or the like, for reading an executable program stored on the memory, such as at least one of the methods shown in FIG. 2, FIG. 5 to FIG. 9.

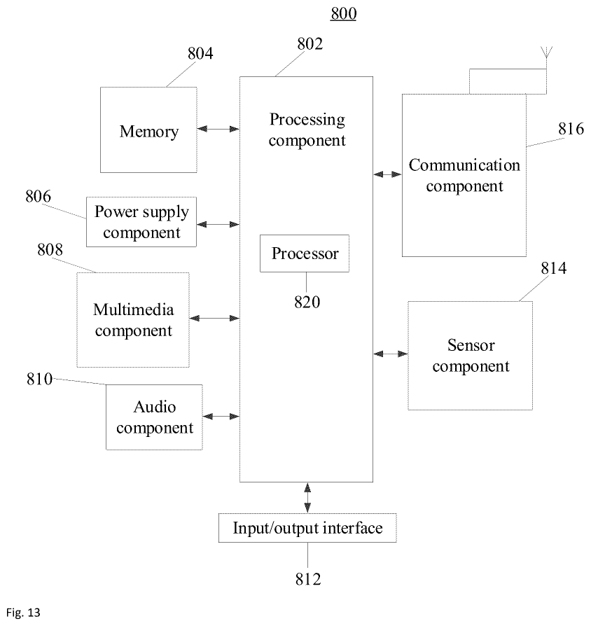

FIG. 13 is a block diagram of a terminal 800 shown according to an example. For example, the terminal 800 may be a mobile telephone, a computer, digital broadcast user equipment, a message transceiving device, a game console, a tablet device, a medical device, a fitness device, a personal digital assistant, and the like.

Referring to FIG. 13, the terminal 800 may include one or more of the following components: a processing component 802, a memory 804, a power supply component 806, a multimedia component 808, an audio component 810, an input/output (I/O) interface 812, a sensor component 814, and a communication component 816.

The processing component 802 controls overall operation of the terminal 800, such as operations associated with displaying, telephone calling, data communication, a camera operation and a record operation. The processing component 802 may include one or more processors 820 to execute instructions, so as to generate all or part of steps of the above method. In addition, the processing component 802 may include one or more modules, so as to facilitate interaction between the processing component 802 and other components. For example, the processing component 802 may include a multimedia module, so as to facilitate interaction between the multimedia component 808 and the processing component 802.

The memory 804 is configured to store various types of data so as to support operations on the terminal 800. Examples of these data include instructions of any application program or method configured to be operated on the terminal 800, contact data, telephone directory data, messages, pictures, videos, and the like. The memory 804 may be implemented by any type of volatile or nonvolatile storage device or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply component 806 provides electric power for various components of the terminal 800. The power supply component 806 may include a power management system, one or more power sources, and other components associated with generating, managing and distributing electric power for the terminal 800.

The multimedia component 808 includes a screen providing an output interface between the terminal 800 and a user. In some examples, the screen may include a liquid crystal display (LCD) and a touch panel (TP). If the screen includes the touch panel, the screen may be implemented as a touch screen so as to receive an input signal from the user. The touch panel includes one or more touch sensors to sense touching, swiping and gestures on the touch panel. The touch sensor may not merely sense a boundary of a touching or swiping action, but also detect duration and pressure related to the touching or swiping operation. In some examples, the multimedia component 808 includes a front camera and/or a back camera. When the terminal 800 is in an operation mode, such as a shooting mode or a video mode, the front camera and/or the back camera may receive external multimedia data. Each front camera and each back camera may be a fixed optical lens system or have a focal length and optical zooming capability.

The audio component 810 is configured to output and/or input an audio signal. For example, the audio component 810 includes a microphone (MIC). When the terminal 800 is in the operation mode, such as a call mode, a recording mode or a speech recognition mode, the microphone is configured to receive an external audio signal. The received audio signal may be further stored in the memory 804 or sent via the communication component 816. In some examples, the audio component 810 further includes a speaker for outputting the audio signal.

The I/O interface 812 provides an interface between the processing component 802 and a peripheral interface module, and the above peripheral interface module may be a keyboard, a click wheel, buttons, etc. These buttons may include but are not limited to: a home button, a volume button, a start button and a lock button.

The sensor component 814 includes one or more sensors for providing state evaluations of all aspects for the terminal 800. For example, the sensor component 814 may detect an on/off state of the terminal 800 and relative positioning of components, for example, the components are a display and a keypad of the terminal 800. The sensor component 814 may further detect position change of the terminal 800 or one component of the terminal 800, whether there is contact between the user and the terminal 800, azimuth or speed up/speed down of the terminal 800, and temperature change of the terminal 800. The sensor component 814 may include a proximity sensor, which is configured to detect existence of a nearby object without any physical contact. The sensor component 814 may further include an optical sensor, such as a CMOS or CCD image sensor, for use in an imaging application. In some examples, the sensor component 814 may further include an acceleration sensor, a gyroscope sensor, a magnetic sensor, a pressure sensor or a temperature sensor.

The communication component 816 is configured to facilitate wired or wireless communication between the terminal 800 and other devices. The terminal 800 may access into a wireless network based on a communication standard, such as WiFi, 2G or 3G, or their combination. In one example, the communication component 816 receives a broadcast signal or broadcast related information from an external broadcast management system via a broadcast channel. In an example, the communication component 816 further includes a near-field communication (NFC) module so as to facilitate short-range communication. For example, the NFC module may be implemented based on a radio frequency identification (RFID) technology, an infrared data association (IrDA) technology, an ultra wide band (UWB) technology, a Bluetooth (BT) technology and other technologies.

In the example, the terminal 800 may be implemented by one or more application specific integrated circuits (ASICs), digital signal processors (DSPs), digital signal processing devices (DSPDs), programmable logic devices (PLDs), field-programmable gate arrays (FPGAs), controllers, microcontrollers, microprocessors or other electronic elements for executing the above method.

In the example, a non-transitory computer readable storage medium including instructions is further provided, such as a memory 804 including instructions. The above instructions may be executed by a processor 820 of the terminal 800 so as to generate the above method. For example, the non-transitory computer readable storage medium may be an ROM, a random access memory (RAM), a CD-ROM, a magnetic tape, a floppy disk, an optical data storage device and the like.

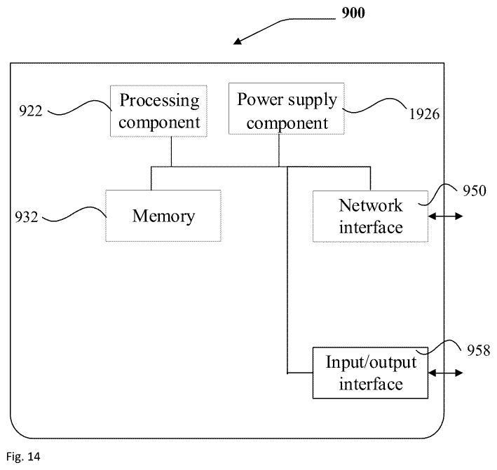

As shown in FIG. 14, an example of the disclosure shows a structure of a communication device 900. For example, the communication device 900 may be provided as a network-side device. The communication device 900 may be the base station.

Referring to FIG. 14, the communication device 900 includes a processing component 922, which further includes one or more processors, and a memory resource represented by a memory 932, for storing instructions executable by the processing component 922, such as an application program. The application program stored in the memory 932 may include one or more modules with each corresponding to a set of instructions. In addition, the processing component 922 is configured to execute the instructions so as to execute any of the above methods applied to the base station for execution, such as at least one of the methods shown in FIG. 2, FIG. 5 to FIG. 9.

The communication device 900 may further include a power supply component 1926 configured to execute power supply management of the communication device 900, a wired or wireless network interface 950 configured to connect the communication device 900 to a network, and an input/output (I/O) interface 958. The communication device 900 may operate based on an operating system stored in a memory 932, such as Windows Server™, Mac OS XTM, Unix™, Linux™, FreeBSD™ or the like.

According to the technical solutions provided by the example of the disclosure, the same LMF unit is selected for the plurality of UEs involved in ranging and/or sidelink positioning. In this way, by controlling the plurality of UEs that require ranging and/or sidelink positioning through the same LMF unit, the number of occupied LMF units is reduced in a process of performing ranging and/or sidelink positioning, and communication interaction among the plurality of LMF units can be reduced, thus complexity of collaborative work among the plurality of LMF units is reduced, and efficiency of ranging and/or sidelink positioning processing process is improved.

Those of skill in the art will easily figure out other implementation solutions of the disclosure after considering the specification and practicing the invention disclosed here. The disclosure intends to cover any transformation, usage or adaptive change of the disclosure, and these transformations, usages or adaptive changes conform to a general principle of the disclosure and include common general knowledge or conventional technical means which are not disclosed here in the technical field. The specification and the examples are merely regarded as an example, and the true scope and spirit of the disclosure are indicated by the following claims.

It is to be appreciated that the disclosure is not limited to the exact construction that has been described above and shown in the accompanying drawings, and that various modifications and changes may be made without departing from its scope. It is intended that the scope of the disclosure merely be limited by the appended claims.

1. A method for processing information, performed by a first access and mobility management function (AMF) unit, comprising:
selecting the same location management function (LMF) unit for a plurality of user equipments (UEs) involved in at least one of ranging or sidelink positioning.

2. The method according to claim 1, wherein selecting the same LMF unit for the plurality of UEs involved in at least one of ranging or sidelink positioning comprises:
selecting, in a case where at least one of a ranging or sidelink positioning request is received, the same LMF unit for the plurality of UEs based on an AMF unit providing a service to the plurality of UEs; wherein the plurality of UEs are indicated by at least one of the ranging or sidelink positioning request.

3. The method according to claim 2, wherein selecting the same LMF unit for the plurality of UEs based on the AMF unit providing the service to the plurality of UEs comprises:
selecting an LMF unit for first UE served by the first AMF unit among the plurality of UEs;
determining whether at least one second UE indicated by at least one of the ranging or sidelink positioning request is served by the first AMF unit;
determining a second AMF unit providing a service to the second UE in a case where the second UE is not served by the first AMF unit; and
selecting the same LMF unit for the second UE based on the LMF unit and the second AMF unit.

4. The method according to claim 3, wherein selecting the same LMF unit for the second UE based on the LMF unit and the second AMF unit comprises:
indicating the LMF unit to the second AMF unit, and selecting the same LMF unit for the second UE; or
indicating the second AMF unit to the LMF unit, and selecting the same LMF unit for the second UE.

5. (canceled)

6. The method according to claim 4, wherein indicating the second AMF unit to the LMF unit comprises:
sending a unit identifier of the second AMF unit to the LMF unit.

7. The method according to claim 3, wherein the method further comprises:
selecting, in a case where the second UE is served by the first AMF unit, the same LMF unit for the second UE by indicating a UE identifier of the second UE to the LMF unit.

8. The method according to claim 7, wherein indicating the UE identifier of the second UE to the LMF unit comprises:
sending a connection request carrying the UE identifier of the second UE to the LMF unit.

9. The method according to claim 3, wherein determining the second AMF unit providing the service to the second UE comprises:
querying, based on a UE identifier of the second UE, a unified data management (UDM) unit for the second AMF unit providing the service to the second UE.

10. The method according to claim 3, wherein the method further comprises:
establishing connections between the plurality of UEs and the LMF unit through the first AMF unit and the second AMF unit.

11. The method according to claim 1, wherein the method further comprises:
receiving at least one of a ranging or sidelink positioning result sent by the LMF unit; and
reporting at least one of the ranging or sidelink positioning result.

12. A method for processing information, performed by an location management function (LMF) unit, comprising:
performing at least one of ranging or sidelink positioning on a plurality of user equipments (UEs) by establishing connections with the plurality of UEs.

13. The method according to claim 12, wherein establishing the connections with the plurality of UEs comprises:
establishing a connection with first UE served by a first access and mobility management function (AMF) unit through the first AMF unit;
receiving a unit identifier, sent by the first AMF unit, of a second AMF unit providing a service to second UE; and
establishing a connection with the second UE by sending a connection request to the second AMF unit based on the unit identifier;
or
establishing a connection with first UE served by a first AMF unit through the first AMF unit;
receiving a connection request sent by a second AMF unit providing a service to second UE; and
establishing a connection with the second UE based on the connection request;
or
establishing a connection with first UE served by a first AMF unit through the first AMF unit;
receiving a connection request sent by the first AMF unit; and
establishing a connection with second UE based on a UE identifier, carried by the connection request, of the second UE served by the first AMF unit.

14.-15. (canceled)

16. The method according to claim 12, wherein the method further comprises:
determining an indication information and a calculation mode for at least one of ranging or sidelink positioning information based on capability negotiation results with the plurality of UEs;
sending the indication information to the plurality of UEs;
obtaining at least one of a ranging or sidelink positioning result by calculating, based on the calculation mode, the ranging or sidelink positioning information sent by the plurality of UEs based on the indication information; and
sending at least one of the ranging or sidelink positioning result to a first AMF unit.

17. The method according to claim 16, wherein the method further comprises:
acquiring, based on the calculation mode, at least one of the ranging or sidelink positioning result calculated and sent by at least one of the plurality of UEs based on the indication information.

18. The method according to claim 16,
wherein the capability negotiation results comprise at least one of the following:
at least one of ranging or sidelink positioning capabilities of the plurality of UEs;
at least one of a ranging or sidelink positioning capability of the LMF unit; or
a calculation node indicated by the UE for calculating at least one of the ranging or sidelink positioning information; and
the indication information indicates at least one of the following:
performing at least one of ranging or sidelink positioning among the plurality of UEs;
sending at least one of the ranging or sidelink positioning information to the LMF unit by the plurality of UEs; or sending at least one of the ranging or sidelink positioning result to the LMF unit by the plurality of UEs.

19. (canceled)

20. A method for processing information, performed by a second access and mobility management function (AMF) unit, comprising:
determining the same location management function (LMF) unit selected for a plurality of user equipment (UEs) involved in at least one of ranging or sidelink positioning.

21. The method according to claim 20, wherein determining the same LMF unit selected for the plurality of UEs involved in at least one of the ranging or sidelink positioning comprises:
determining the LMF unit indicated by the first AMF unit and selected for the plurality of UEs involved in at least one of the ranging or sidelink positioning.

22.-29. (canceled)

30. A communication device, comprising one or more processors, a memory, and an executable program stored on the memory and capable of being run by the one or more processors, wherein the one or more processors, when running the executable program, execute the method provided by claim 1.

31. (canceled)

32. A communication device, comprising one or more processors, a memory, and an executable program stored on the memory and capable of being run by the one or more processors, wherein the one or more processors, when running the executable program, execute the method provided by claim 12.

33. A communication device, comprising one or more processors, a memory, and an executable program stored on the memory and capable of being run by the one or more processors, wherein the one or more processors, when running the executable program, execute the method provided by claim 20.
